(19) United States
(12) Patent Application Publication
(10) Pub. No.: US 2010/0031784 A1
(43) Pub. Date: Feb. 11, 2010

(54) U-Joint or Locking Extension with a Socket

(76) Inventor: Johnxing Situ, Gilbert, AZ (US)

Correspondence Address: WILSON DANIEL SWAYZE, JR., 3804 CLEARWATER CT., PLANO, TX, 75025, US

(21) Appl. No.: 12/185,834

(22) Filed: Aug. 5, 2008

(51) Int. Cl. B25B 23/00

(52) U.S. Cl. 81/177.75

(57) ABSTRACT

An extension device for a socket member may include a ratchet member, a first U-joint member connecting the ratchet member and the socket member, a first sleeve member for connecting the ratchet member and the socket member to inhibit the operation of the first U-joint member. The sleeve member may include a threaded connection to the ratchet member, and the U-joint member may include a first ball and socket member. The U-joint member may include a first central shaft member, and the first central shaft member may radially rotate on a first traverse shaft member. The traverse shaft member may be connected to a first pair of arms, and the first arms may be connected to the socket member. The extension device may include a second U-joint member, and the extension device may include a second sleeve member to inhibit the operation of the second U-joint member. The second sleeve member may include a threaded connection, and the second U-joint member may include a second ball and socket member.

This invention relates generally to tools and more particularly, to an improved extension member for use with a wrench and socket and wherein the extension member includes a locking mechanism to deter unwanted separation of a socket from the extension member.

### BACKGROUND OF THE INVENTION

No doubt one of the most frequently utilized tools of a mechanic, particularly an automotive mechanic, is the socket wrench. This tool comprises a wrench of any one of various types having a square drive element adapted to engage in a snap-fit manner, a square cavity as formed in any one of various sizes of socket elements, the latter destined to captively engage the polygonal periphery of either a nut or the head of a bolt/machine screw. When operating around larger pieces of equipment, such as motor vehicles and construction machinery, the need frequently exists to apply or remove threaded fasteners which are not readily accessible in view of cramped quarters immediately surrounding the fastener. In these cases, one applies an extension element intermediate the wrench and socket and which comprises an elongated element having a female upper end engaged by the wrench drive element and an opposite male end similar in configuration to the wrench drive element and which is snap-fitted into the socket.

This invention relates to a universal joint of the type comprising first and second parts, wherein the first part defines a recess configured to receive a drive stud of a torque transmitting tool and the second part comprises a drive stud configured to engage a tool head. At least one coupling element is positioned between the first and second parts to transmit torque therebetween while allowing the first and second parts to rotate with the first part positioned in a skew orientation with respect to the second part.

Universal joints of this type are in common use with torque transmitting tools such as socket wrenches. See for example the constant velocity type universal joint described in Hazebrook U.S. Pat. No. 4,941,8622. Conventional universal joints include a spring biased detent ball on the drive stud that engages the recess of the tool head that is mounted to the universal joint to provide a retention force that cannot be readily altered or selected by the user.

U.S. Pat. No. 6,119,559 discloses a socket wrench extension having an insertion member having a polygonal socket head with a lateral socket head surface. A receiving member with a polygonal receiving socket is provided.

A joint connects the insertion member to the receiving member. A locking element is moveably connected within the insertion member such that the locking element partially projects from the lateral socket head surface. A pressure transmission member is axially movable in the insertion member. The pressure transmission member has a first end with a key head and a second end. The key head serves as an actuating member for the pressure transmission member. The second end transforms axial movement of the pressure transmission member into an outward movement of the locking element.

### SUMMARY

An extension device for a socket member may include a ratchet member, a first U-joint member connecting the ratchet member and the socket member, a first sleeve member for connecting the ratchet member and the socket member to inhibit the operation of the first U-joint member.

The sleeve member may include a threaded connection to the ratchet member, and the U-joint member may include a first ball and socket member.

The U-joint member may include a first central shaft member, and the first central shaft member may radially rotate on a first traverse shaft member.

The traverse shaft member may be connected to a first pair of arms, and the first arms may be connected to the socket member.

The extension device may include a second U-joint member, and the extension device may include a second sleeve member to inhibit the operation of the second U-joint member.

The second sleeve member may include a threaded connection, and the second U-joint member may include a second ball and socket member.

The second U-joint member may include a second central shaft member, and the second central shaft member may radially rotate on a second traverse shaft member.

The second traverse shaft member may be connected to a second pair of arms.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a side view of the extension device of the present invention in an open position;

FIG. 2 illustrates a side view of the extension device of the present invention in a closed position;

FIG. 3 illustrates a side view of another extension device of the present invention in an open position;

FIG. 4 illustrates a side view of another extension device of the present invention in a closed position;

FIG. 5 illustrates a side view of another extension device of the present invention in an open position;

FIG. 6 illustrates a side view of another extension device of the present invention in a closed position;

FIG. 7 illustrates a side view of another extension device of the present invention in an open position;

FIG. 8 illustrates a side view of another extension device of the present invention in a closed position.

### DETAILED DESCRIPTION

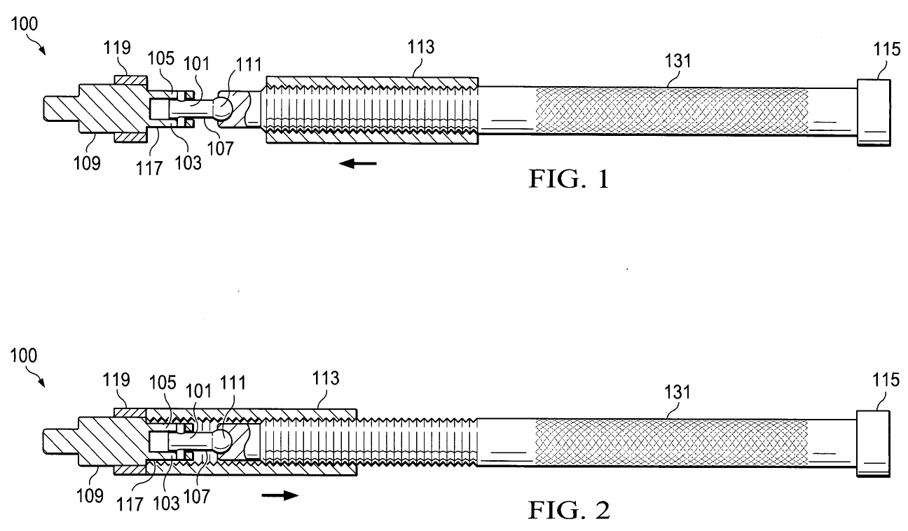

FIG. 1 may illustrate a single U-joint (universal joint) or locking extension which may have a single U-joint. The extension device 100 can be locked by moving the first sleeve member 113 over the U-joint member 117 allowing the extension device 100 to be used as a standard extension device. Additionally, the extension device 100 may be unlocked by moving the first sleeve member 113 to the original position. In the original position, the extension device 100 can be used as a U-joint. The present invention is advantageous in that the extension device 100 may be used as a U-joint device and an extension device. The present invention is advantageous to reach difficult areas for example the transmission pan. The extension device of the present invention may be available in various sizes for example 8 inches 12 inches or shorter lengths.

The extension device 100 may include a U-joint member 117 connected to an end member 109 which may include different size ends to correspond to the needs of the user. The U-joint member 117 allows the end member 109 to both axially rotate or to radially turn. The U-joint member 117 may include a central shaft member 107 to connect to the ball and socket member 111 to permit axial rotation. The U-joint member 117 may include a first arm member 103 and a second arm member 105 to connect to a traverse shaft member 101 to cooperate with an aperture in the central shaft member 107 to allow the central shaft member 107 to radially turn with respect to the first arm member 103 and the second arm member 105. The first arm member 103 and the second arm member 105 may be connected to the end member 109, and the ball and socket member 111 may be connected to the body handle member 117. The extension device 100 may include a first sleeve member 113 which may be in threaded connection with the body handle member 131. The first sleeve member 113 may have internal threads to cooperate with external threads of the body handle member 117. By rotation of the first sleeve member 113 with respect to the body handle member 131, the first sleeve member 113 may cover the user joint member 117 and may connect with the second sleeve member 119 which is positioned on the end member 109. As a result, the U-joint member 117 may be substantially in-operative in order to provide a rigid extension device 100. The first sleeve member 113 may be rotated with respect to the body handle 131 to uncover the U-joint member 117 and allow the U-joint member 117 to provide axial rotation and radial movement.

FIG. 2 illustrates the extension device 100 in a closed position. FIG. 2 illustrates that the first sleeve member 113 has been rotated to cover the joint member 117 and has been position adjacent to the second sleeve member 119. The first sleeve member 113 connects the end member 109 with the body handle member 131 which may be connected to the ratchet member 115.

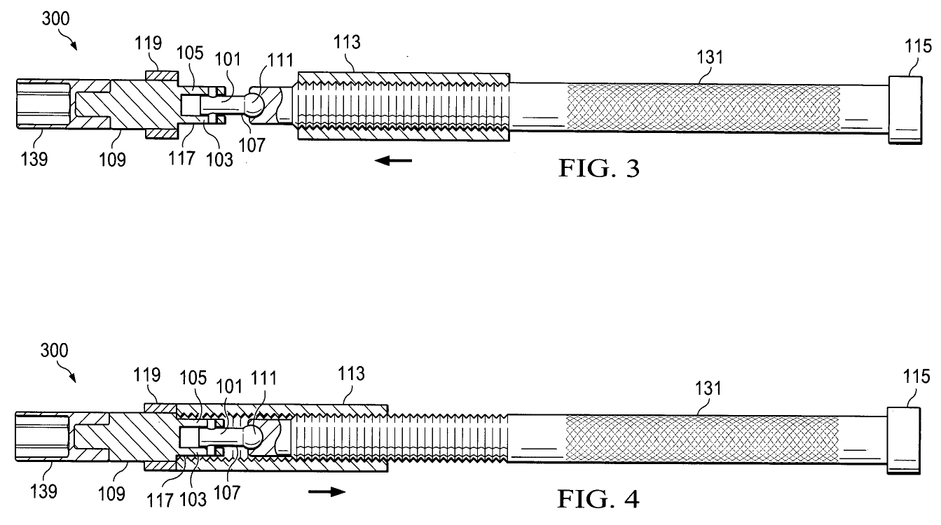

FIG. 3 may illustrate a single U-joint or locking extension which may have a single U-joint. The extension device 300 can be locked by moving the first sleeve member 113 over the U-joint member 117 allowing the extension device 300 to be used as a standard extension device. Additionally, the extension device 300 may be unlocked by moving the first sleeve member 113 to the original position. In the original position, the extension device 300 can be used as a U-joint. The present invention is advantageous in that the extension device 300 may be used as a U-joint device and an extension device. The present invention is advantageous to reach difficult areas for example the transmission pan. The extension device 300 of the present invention may be available in various sizes for example 8 inches 12 inches or shorter lengths.

The extension device 300 may include a U-joint member 117 connected to a socket member 139 which may include different size sockets to correspond to the needs of the user. The socket member 139 may include a torx bit, a hex bit, a screwdriver bit or other device to aid a technician to reach difficult areas which may be hard to reach for example removing the dash in the vehicle. The U-joint member 117 allows the socket member 139 to both axially rotate or to radially turn. The U-joint member 117 may include a central shaft member 107 to connect to the ball and socket member 111 to permit axial rotation. The U-joint member 117 may include a first arm member 103 and a second arm member 105 to connect to a traverse shaft member 101 to cooperate with an aperture in the central shaft member 107 to allow the central shaft member 107 to radially turn with respect to the first arm member 103 and the second arm member 105. The first arm member 103 and the second arm member 105 may be connected to the socket member 139, and the ball and socket member 111 may be connected to the body handle member 117. The extension device 100 may include a first sleeve member 113 which may be in threaded connection with the body handle member 131. The first sleeve member 113 may have internal threads to cooperate with external threads of the body handle member 131. By the rotation of the first sleeve member 113 with respect to the body handle member 131, the first sleeve member 113 may cover the user joint member 117 and may connect with the second sleeve member 119 which is positioned on the end member 109. As a result, the U-joint member 117 may be substantially in-operative in order to provide a rigid extension device 300. The first sleeve member 113 may be rotated with respect to the body handle 131 to uncover the U-joint member 117 and allow the U-joint member 117 to provide axial rotation and radial movement.

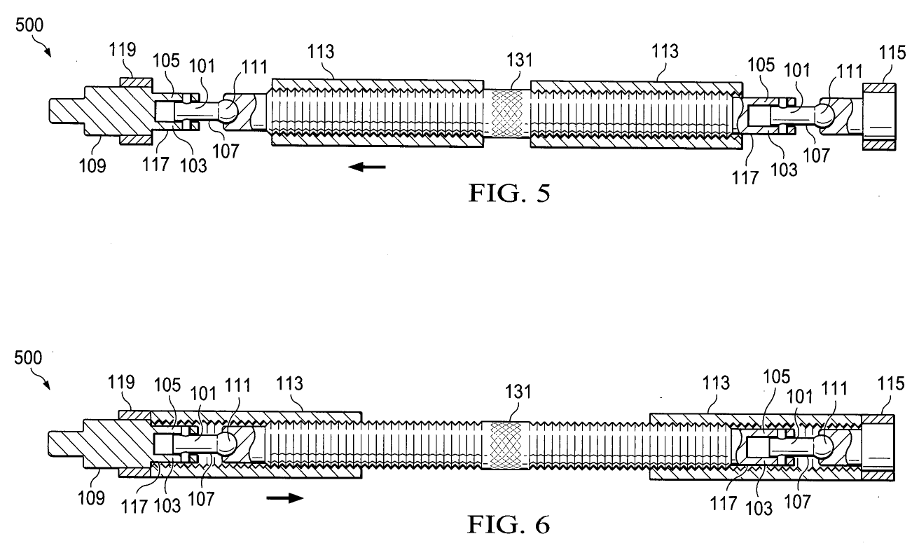

FIG. 5 illustrates an extension device 500 having a first and second U-joint 117 at each end of the extension device 500. The first and second U-joint 117 are substantially the same with the first U-joint member 117 being connected to the end member 109 and the second U-joint member 117 being connected to the ratchet member 115. FIG. 5 illustrates that the sleeve member 115 may be in the open position while FIG. 6 illustrates that the sleeve member 115 may be in the closed position. One sleeve member 115 may be in the open position while on the other sleeve member 115 may be in the closed position.

FIG. 4 illustrates the extension device 300 in a closed position. FIG. 4 illustrates that the first sleeve member 113 has been rotated to cover the joint member 117 and has been position adjacent to the second sleeve member 119. The first sleeve member 113 may connect the socket member 139 with the body handle member 131 which may be connected to the ratchet member 115.

FIG. 5 may illustrate a U-joint or locking extension which may have a two or more U-joints. The extension device 500 can be locked by moving the each of the first sleeve members 113 over each of the respective U-joint members 117 allowing the extension device 500 to be used as a standard extension device. Additionally, the extension device 500 may be unlocked by moving each of the first sleeve members 113 to the original position. In the original position, the extension device 500 can be used as a U-joint. The present invention is advantageous in that the extension device 500 may be used as a U-joint device and an extension device. The present invention is advantageous to reach difficult areas for example the transmission pan of a vehicle. The extension device of the present invention may be available in various sizes for example 8 inches 12 inches or shorter lengths.

The extension device 500 may include a U-joint member 117 connected to an end member 109 which may include different size ends to correspond to the needs of the user and a U-joint member 117 connected to the ratchet member 115. The U-joint member 117 allows the end member 109 to both axially rotate or to radially turn. The U-joint member 117 may include a central shaft member 107 to connect to the ball and socket member 111 to permit axial rotation. The U-joint member 117 may include a first arm member 103 and a second arm member 105 to connect to a traverse shaft member 101 to cooperate with an aperture in the central shaft member 107 to allow the central shaft member 107 to radially turn with respect to the first arm member 103 and the second arm member 105. The first arm member 103 and the second arm member 105 may be connected to the end member 109, and the ball and socket member 111 may be connected to the body handle member 117. The extension device 500 may include a first sleeve member 113 which may be in threaded connection with the body handle member 131. The first sleeve member 113 may have internal threads to cooperate with external threads of the body handle member 131. By rotation of the first sleeve member 113 with respect to the body handle member 131, the first sleeve member 113 may cover the user joint member 117 and may connect with the second sleeve member 119 which is positioned on the end member 109. As a result, the U-joint member 117 may be substantially in-operative in order to provide a rigid extension device 100. The first sleeve member 113 may be rotated with respect to the body handle 131 to uncover the U-joint member 117 and allow the U-joint member 117 to provide axial rotation and radial movement.

FIG. 6 illustrates the extension device 500 in a closed position. FIG. 6 illustrates that each of the first sleeve members 113 has been rotated to cover the joint member 117 and has been position adjacent to the second sleeve member 119. The first sleeve member 113 connects the end member 109 with the body handle member 131 which may be connected to the ratchet member 115.

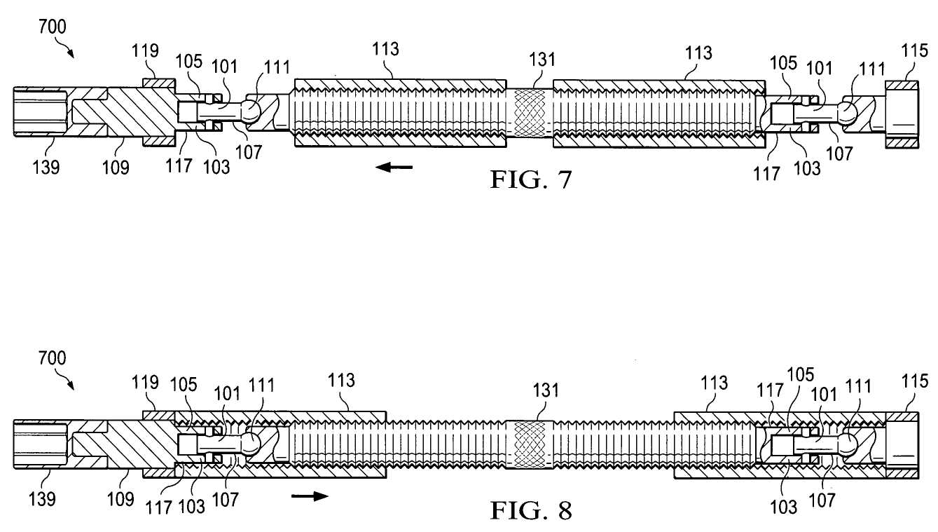

FIG. 7 may illustrate a U-joint or locking extension which may have a two or more U-joints. The extension device 700 can be locked by moving the each of the first sleeve members 113 over each of the respective U-joint members 117 allowing the extension device 700 to be used as a standard extension device. Additionally, the extension device 700 may be unlocked by moving each of the first sleeve members 113 to the original position. In the original position, the extension device 700 can be used as a U-joint. The present invention is advantageous in that the extension device 700 may be used as a U-joint device and an extension device. The present invention is advantageous to reach difficult areas for example the transmission pan of a vehicle. The extension device 700 of the present invention may be available in various sizes for example 8 inches 12 inches or shorter lengths.

The extension device 700 may include a U-joint member 117 connected to an socket member 139 which may include different size sockets to correspond to the needs of the user and a U-joint member 117 connected to the ratchet member 115. The U-joint member 117 allows the socket member 139 to both axially rotate or to radially turn. The socket member 139 may include a torx bit, a hex bit, a screwdriver bit or other device to aid a technician to reach difficult areas which may be hard to reach for example removing the dash in the vehicle. The U-joint member 117 may include a central shaft member 107 to connect to the ball and socket member 111 to permit axial rotation. The U-joint member 117 may include a first arm member 103 and a second arm member 105 to connect to a traverse shaft member 101 to cooperate with an aperture in the central shaft member 107 to allow the central shaft member 107 to radially turn with respect to the first arm member 103 and the second arm member 105. The first arm member 103 and the second arm member 105 may be connected to the end member 109, and the ball and socket member 111 may be connected to the body handle member 117. The extension device 700 may include a first sleeve member 113 which may be in threaded connection with the body handle member 131. The first sleeve member 113 may have internal threads to cooperate with external threads of the body handle member 131. By rotation of the first sleeve member 113 with respect to the body handle member 131, the first sleeve member 113 may cover the user joint member 117 and may connect with the second sleeve member 119 which is positioned on the end member 109. As a result, the U-joint member 117 may be substantially in-operative in order to provide a rigid extension device 700. The first sleeve member 113 may be rotated with respect to the body handle 131 to uncover the U-joint member 117 and allow the U-joint member 117 to provide axial rotation and radial movement.

FIG. 6 illustrates the extension device 700 in a closed position. FIG. 6 illustrates that each of the first sleeve members 113 has been rotated to cover the joint member 117 and has been position adjacent to the second sleeve member 119. The first sleeve member 113 connects the end member 109 with the body handle member 131 which may be connected to the ratchet member 115.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. An extension device for a socket member, comprising:
a ratchet member;
a first U-joint member connecting the ratchet member and the socket member;
a first sleeve member for connecting the ratchet member and the socket member to inhibit the operation of the first U-joint member.

2. An extension device for a socket member as in claim 1, wherein the sleeve member includes a threaded connection to the ratchet member.

3. An extension device for a socket member as in claim 1, wherein the U-joint member includes a first ball and socket member.

4. An extension device for a socket member as in claim 1, wherein the U-joint member includes a first central shaft member.

5. An extension device for a socket member as in claim 4, wherein the first central shaft member radially rotates on a first traverse shaft member.

6. An extension device for a socket member as in claim 5, wherein the traverse shaft member is connected to a first pair of arms.

7. An extension device for a socket member as in claim 6, wherein the first arms are connected to the socket member.

8. An extension device for a socket member as in claim 1, wherein the extension device includes a second U-joint member.

9. An extension device for a socket member as in claim 8, wherein the extension device includes a second sleeve member to inhibit the operation of the second U-joint member.

10. An extension device for a socket member as in claim 9, wherein the second sleeve member includes a threaded connection.

11. An extension device for a socket member as in claim 8, wherein the second U-joint member includes a second ball and socket member.

12. An extension device for a socket member as in claim 8, wherein the second U-joint member includes a second central shaft member.

13. An extension device for a socket member as in claim 12, wherein the second central shaft member radially rotates on a second traverse shaft member.

14. An extension device for a socket member as in claim 5, wherein the second traverse shaft member is connected to a second pair of arms.
